(19) United States
(12) Patent Application Publication
(10) Pub. No.: US 2017/0026704 A1
(43) Pub. Date: Jan. 26, 2017

(54) METHOD OF SETTING MAPPING BETWEEN CHANNEL NUMBER AND PROGRAM NUMBER

(71) Applicant: MEDIATEK INC., Hsin-Chu (TW)

(72) Inventors: Yu-Hsiung Deng, Hsin-Cju Hsien (TW); Ching-Chieh Wang, Yilan County (TW)

(21) Appl. No.: 15/283,440

(22) Filed: Oct. 2, 2016

Related U.S. Application Data
(63) Continuation of application No. 12/324,885, filed on Nov. 27, 2008, now abandoned.
(60) Provisional application No. 61/026,160, filed on Feb. 5, 2008.

(51) Int. Cl. H04N 21/462; H04N 21/854; H04N 5/50; H04N 21/438; H04N 21/434; H04N 21/4385

(52) U.S. Cl. CPC H04N 21/4622; H04N 21/4345; H04N 21/4385; H04N 5/50; H04N 21/4383; H04N 21/854

(57) ABSTRACT

A method of setting at least a mapping between a channel number and a program number is provided. The method includes receiving a virtual channel table (VCT) and a program association table (PAT) transmitted via a communication channel, comparing the VCT and the PAT to generate a comparison result, and determining a mapping between a specific channel number and a specific program number according to the comparison result.

### CROSS REFERENCE TO RELATED APPLICATION

This application is a continuation application and claims the benefit of U.S. Non-provisional application Ser. No. 12/324,885, which was filed on 2008 Nov. 27, and is included herein by reference. In addition, the Non-provisional application Ser. No. 12/324,885 claims the benefit of U.S. Provisional Application No. 61/026,160, which was filed on 2008 Feb. 5.

### BACKGROUND

The present invention relates to processing information transmitted via a digital television signal, and more particularly, to a method of setting at least a mapping between a channel number and a program number according to a virtual channel table and/or a program association table.

Generally, a program and system information protocol (PSIP) of an Advanced Television Systems Committee (ATSC) standard for digital television broadcasting contains a virtual channel table (VCT). In addition, the PSIP is defined as the protocol of the ATSC standard for terrestrial and cable digital television broadcasting which parses encoded messages using a moving picture experts group-2 (MPEG-2; ISO/IEC 13818-1) system to thereby provide various kinds of information on the broadcasted programs. There are many communication channels (physical channels) each with a distinct frequency band (RF band) and a physical channel number (RF number). Each of the communication channels (physical channels) is configured for transmitting programs of one or more virtual channels. However, the user is not aware of the physical channel number of the physical channel which is selected to transmit the television program watched by the user; instead, the user makes the channel selection based on the virtual channel numbers. The channel information for the channel selection is contained in the VCT. For example, the VCT records virtual channel numbers and program numbers respectively associated with the virtual channel numbers. In general, each virtual channel number is represented using a major channel number and a minor channel number, where the major and minor channel numbers function as the user reference number for the corresponding virtual channel. Regarding the program number recorded in the VCT, it is used to identify a corresponding program transmitted via the digital television broadcasting.

Although ATSC is forced by law, PSIP tables, including the VCT, are not necessary found in each digital channel broadcasted bitstream. Even though the VCT can be derived a digital channel broadcasted bitstream, the actual content of the VCT might be incomplete. In other words, the VCT entries do not include all of the program numbers of the available programs transmitted via the digital channel broadcasted bitstream on a physical channel. Only using the VCT to create a channel list that records channels available for users to select from sometimes fails to obtain a satisfactory result. Therefore, how to properly determine a mapping between a virtual channel number and a program number becomes an important issue for system designers.

### SUMMARY

According to one aspect of the present invention, a method of setting at least a mapping between a channel number and a program number is provided. The method may include: retrieving information from a virtual channel table (VCT) and a program association table (PAT) transmitted via a communication channel; comparing the retrieved information of the VCT and the PAT to generate a comparison result; and determining a mapping between a specific channel number and a specific program number according to the comparison result, wherein the program number of the PAT is referenced first before the retrieved information of the VCT is referenced when determining of the mapping.

According to another aspect of the present invention, a method of setting at least a mapping between a channel number and a program number is provided. The method may include: retrieving information from a first table and a second table transmitted via a communication channel, wherein the first table complies with a specific television standard, and the second table complies with a specific moving picture experts group (MPEG) standard; comparing the retrieved information of the first table and the second table to generate a comparison result; and determining a mapping between a specific channel number and a specific program number according to the comparison result, wherein the program number of the PAT is referenced first before the retrieved information of the VCT is referenced when determining of the mapping.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating a method of setting at least a mapping between a virtual channel number and a program number according to a first exemplary embodiment of the present invention.

FIG. 2 is a continued flow of FIG. 1.

FIG. 3 is a diagram illustrating a first example of determining a mapping between a virtual channel number and a program number.

FIG. 4 is a diagram illustrating a second example of determining a mapping between a virtual channel number and a program number.

FIG. 5 is a diagram illustrating a third example of determining a mapping between a virtual channel number and a program number.

FIG. 6 is a diagram illustrating a fourth example of determining a mapping between a virtual channel number and a program number.

FIG. 7 is a diagram illustrating a fifth example of determining a mapping between a virtual channel number and a program number.

FIG. 8 is a diagram illustrating a sixth example of determining a mapping between a virtual channel number and a program number.

FIG. 9 is a diagram illustrating a seventh example of determining a mapping between a virtual channel number and a program number.

FIG. 10 is a diagram illustrating an eighth example of determining a mapping between a virtual channel number and a program number.

FIG. 11 is a diagram illustrating a ninth example of determining a mapping between a virtual channel number and a program number.

FIG. 12 is a flowchart illustrating a method of setting at least a mapping between a virtual channel number and a program number according to a second exemplary embodiment of the present invention.

FIG. 13 is a continued flow of FIG. 12.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

As mentioned in the background description, the MPEG-2 transport stream is used by the PSIP to transmit audio data and video data multiplexed therein. In addition, for each physical channel, a program association table (PAT) is also transmitted via a digital channel broadcast bitstream according to the MPEG-2 specification. The PAT lists all programs available in the transport stream delivered via the corresponding physical channel, and each of the listed programs is identified by a 16-bit value called program number. In addition, each of the programs listed in the PAT has an associated value of a packet identifier (PID) for its program map table (PMT) that describes which PIDs contain data relevant to the desired program. The present invention proposes that the received PAT is involved in setting a mapping between a virtual channel number and a program number. With the help of information given by the PAT, more mappings between the virtual channel numbers and the program numbers can be derived. For example, using the proposed method of the present invention can create a channel list having more entries each recording a virtual channel number mapped to a program number. As a result, compared with the conventional scheme of only using the VCT to create a channel list, the present invention provides the created channel list more listed channels available for the user to select therefrom through a television user interface.

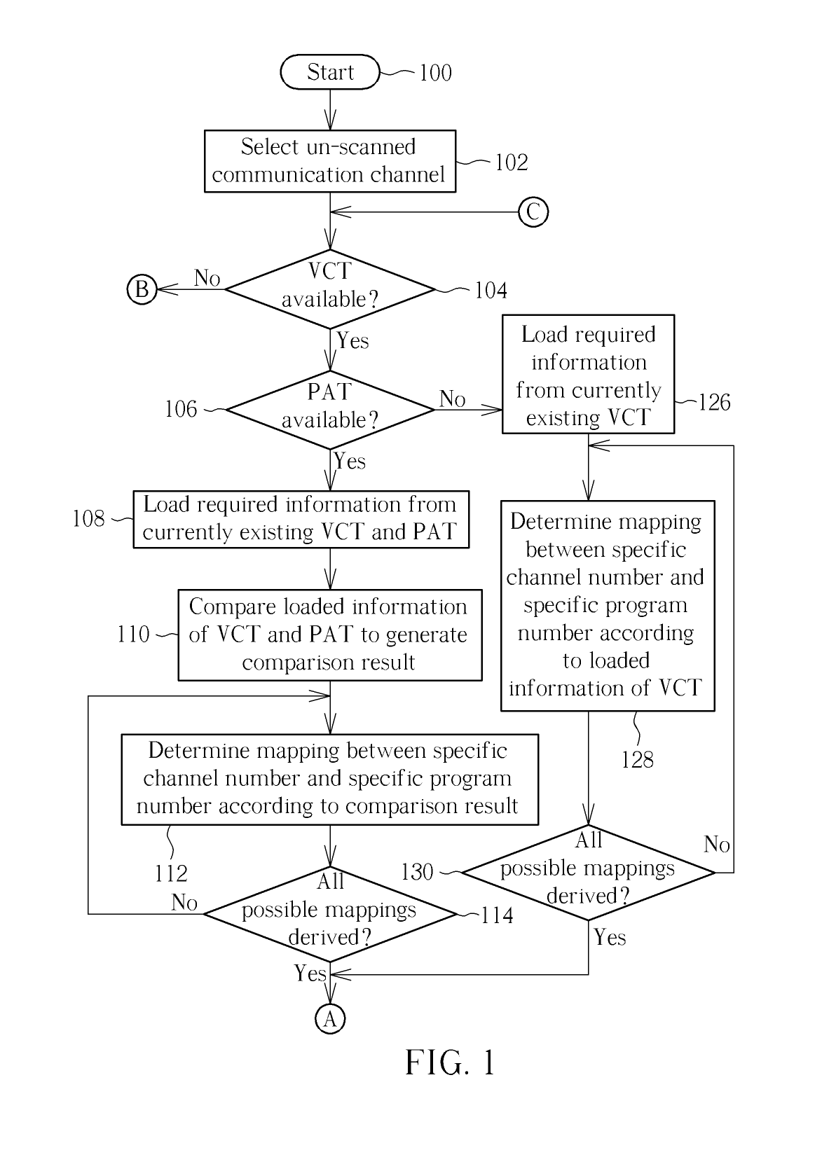

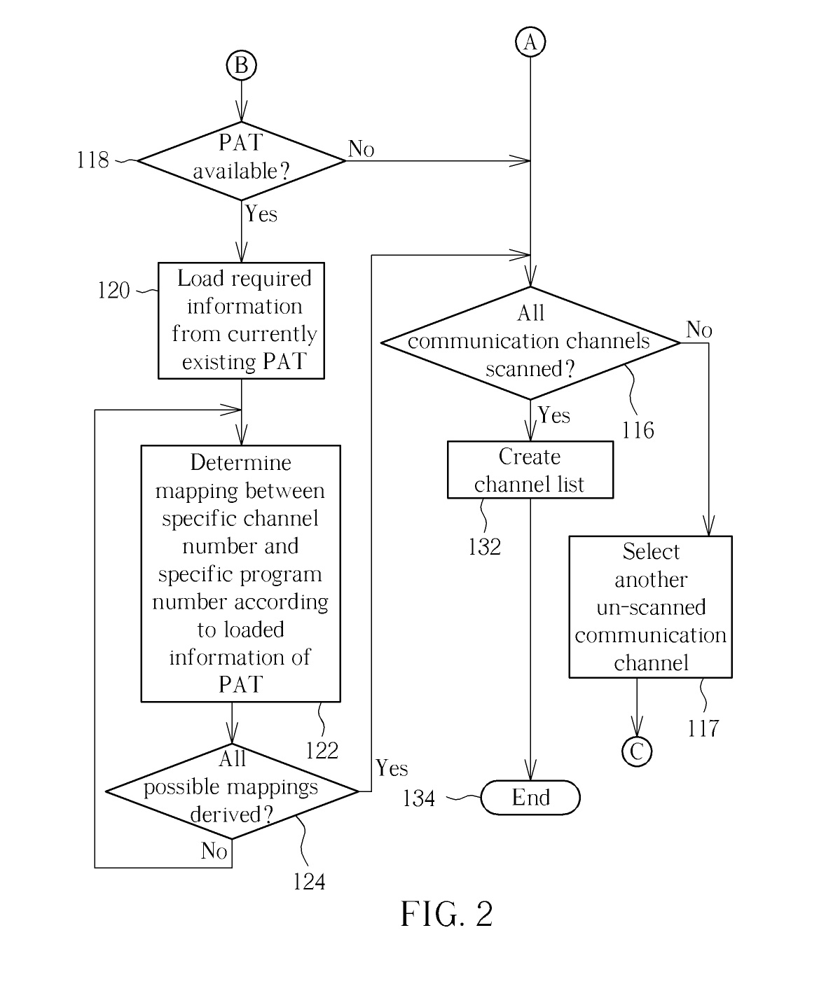

Please refer to FIG. 1 in conjunction with FIG. 2. FIG. 1 is a flowchart illustrating a method of setting at least a mapping between a virtual channel number and a program number according to a first exemplary embodiment of the present invention. FIG. 2 is a continued flow of FIG. 1. Please note that if the result is substantially the same, the steps are not required to be executed in the exact order shown in FIG. 1 and FIG. 2. The exemplary method shown in FIG. 1 and FIG. 2 is employed in a channel list creation process (or so-called channel scan/channel search), and includes steps as follows.

Step 100: Start.

Step 102: Select an un-scanned communication channel (i.e., a physical channel) with a designated physical channel number.

Step 104: Check if a virtual channel table (VCT) exists in the selected communication channel. If yes, go to step 106; otherwise, go to step 118.

Step 106: Check if a program association table (PAT) exists in the selected communication channel. If yes, go to step 108; otherwise, go to step 126.

Step 108: Load required information from currently existing VCT and PAT.

Step 110: Compare the loaded information of VCT and PAT to generate a comparison result.

Step 112: Determine a mapping between a specific channel number and a specific program number according to the comparison result, wherein at least one of the specific channel number and the specific program number is recorded in the loaded information of VCT and PAT.

Step 114: Are all of the possible mappings derived using the loaded information of VCT and PAT? If yes, go to step 116; otherwise, go to step 112 to determine another mapping.

Step 116: Are all of the communication channels (physical channels) scanned? If yes, go to step 132; otherwise, go to step 117.

Step 117: Select an un-scanned communication channel with another designated physical channel number, and then proceed with step 104.

Step 118: Check if a program association table (PAT) exists in the selected communication channel. If yes, go to step 120; otherwise, go to step 116.

Step 120: Load required information from the currently existing PAT.

Step 122: Determine a mapping between a specific channel number and a specific program number according to the loaded information of PAT, wherein the specific program number is recorded in the existing PAT.

Step 124: Are all of the possible mappings derived using the loaded information of PAT? If yes, go to step 116; otherwise, go to step 122 to determine another mapping.

Step 126: Load required information from the currently existing VCT.

Step 128: Determine a mapping between a specific channel number and a specific program number according to the loaded information of VCT, wherein the specific channel number and the specific program number are both recorded in the existing VCT.

Step 130: Are all of the possible mappings derived using the loaded information of VCT? If yes, go to step 116; otherwise, go to step 128 to determine another mapping.

Step 132: Create a channel list according to each mapping between a virtual channel number and a program number that is found using the information of VCT, PAT, or both.

Step 134: End.

The exemplary method applied in the channel list creation process does the VCT and/or PAT information loading per physical channel (Steps 102 and 117). Each frequency band assigned to a physical channel with a designated physical channel number is licensed for broadcasting digital data such as a modulated MPEG-2 compatible bitstream. Ideally, every bitstream should carry the VCT and PAT. However, exceptions might occur. For example, at least one of the VCT and PAT supposed to be received at the receiver end is not available from the selected communication channel. To maximize the number of channels included in a channel list, the present invention uses the information of available VCT, PAT, or both to find all of the possible mappings between the virtual channel numbers and the program numbers. It should be noted that step 108 only loads the required information from the existing VCT and PAT. In other words, a portion of the existing VCT and a portion of the existing PAT are loaded. For instance, in an exemplary implementation of the present invention, only the channel number data and program number data included in the existing VCT and the program number data included in the existing PAT are loaded. The memory requirement can be reduced greatly due to the partial data loading of the existing VCT and PAT. Similarly, steps 120 and 126 are also configured to employ the aforementioned partial data loading scheme.

In a first case where the information of both the VCT and PAT is received via the selected communication channel, each mapping between a virtual channel number and a program number is derived according to a comparison result of the loaded information of VCT and PAT (Steps 108, 110, 112, and 114). In the following, a plurality of examples of using the loaded information of VCT and PAT to determine one or more mappings are presented to illustrate technical features of the present invention.

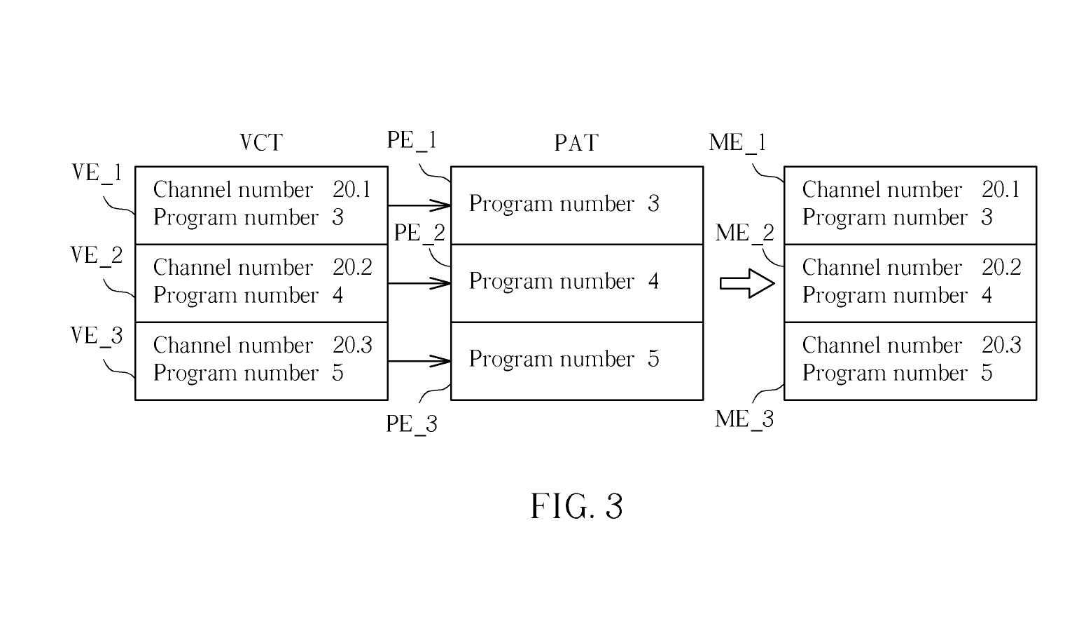

FIG. 3 shows a first example of determining a mapping between a virtual channel number and a program number. As shown, the exemplary loaded information of VCT has three VCT entries VE_1, VE_2, and VE_3. Please note that each exemplary virtual channel number ‘A.B’ used in this or following examples has ‘A’ representative of the major channel number and ‘B’ representative of the minor channel number. As shown in FIG. 3, the VCT entry VE_1 records a channel number 20.1 and a program number 3 mapped to the channel number 20.1; the VCT entry VE_2 records a channel number 20.2 and a program number 4 mapped to the channel number 20.2; and the VCT entry VE_3 records a channel number 20.3 and a program number 5 mapped to the channel number 20.3. Regarding the exemplary loaded information of PAT, it has three PAT entries PE_1, PE_2, and PE_3 which record program numbers 3, 4, and 5, respectively. As one can see, there is no program number inconsistency between the VCT and PAT; in addition, the total number of the VCT entries is equal to the total number of the PAT entries. Therefore, based on the comparison result of the VCT and PAT, it is determined that the channel number 20.1 is mapped to the program number 3, the channel number 20.2 is mapped to the program number 4, and the channel number 20.3 is mapped to the program number 5. In this way, three mapping records ME_1, ME_2, and ME_3 as shown in FIG. 3 are derived.

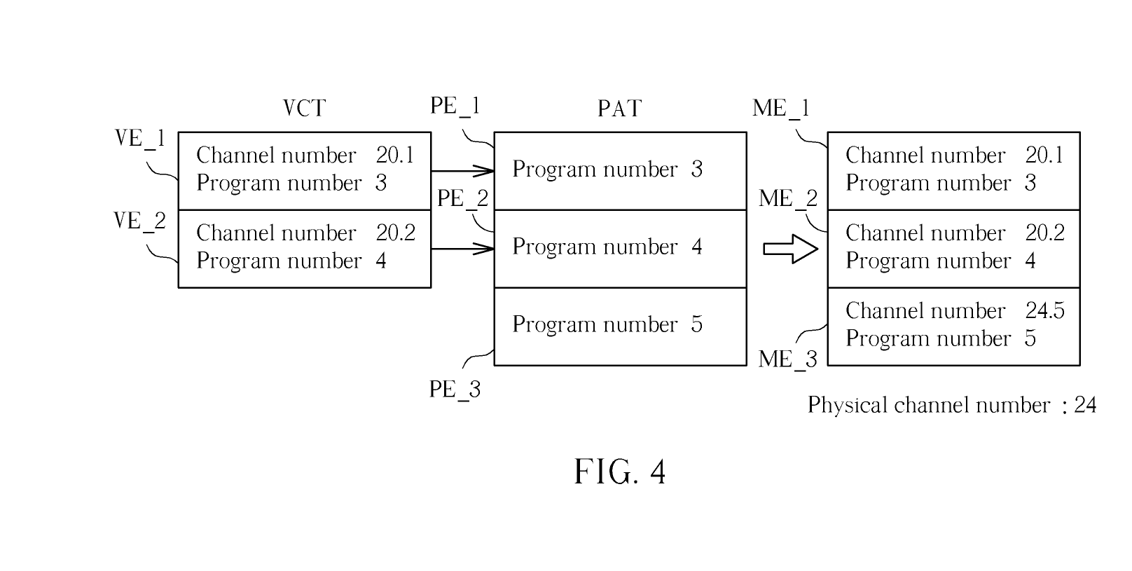

FIG. 4 shows a second example of determining a mapping between a virtual channel number and a program number. As shown, the exemplary loaded information of VCT has two VCT entries VE_1 and VE_2. The VCT entry VE_1 records a channel number 20.1 and a program number 3 mapped to the channel number 20.1. The VCT entry VE_2 records a channel number 20.2 and a program number 4 mapped to the channel number 20.2. Regarding the exemplary loaded information of PAT, it has three PAT entries PE_1, PE_2, and PE_3 which record program numbers 3, 4, and 5, respectively. As one can see, there is program number inconsistency between the VCT and PAT; in addition, the total number of the VCT entries is unequal to the total number of the PAT entries. Specifically, the total number of the VCT entries is less than the total number of the PAT entries. The comparison result of the information of VCT and PAT indicates that the PAT includes PAT entries PE_1 and PE_2 recording program numbers 3 and 4, and the VCT includes VCT entries VE_1 and VE_2 recording program numbers 3 and 4 as well. It is therefore determined that the virtual channel numbers 20.1 and 20.2 recorded in VCT entries VE_1 and VE_2 are mapped to the program numbers 3 and 4, respectively. In addition, the comparison result of the information of VCT and PAT also indicates that the PAT includes a PAT entry PE_3 recording the program number 5 which is not recorded in any VCT entry. Specifically, a new channel number that is not recorded in the VCT will be created and then mapped to the program number 5. Provided that the currently selected physical channel has a designated physical channel number equal to 24, the new channel number can be configured using a major channel number set by the physical channel number 24 and a minor channel number set by the program number 5. In this way, three mapping records ME_1, ME_2, and ME_3 as shown in FIG. 4 are derived.

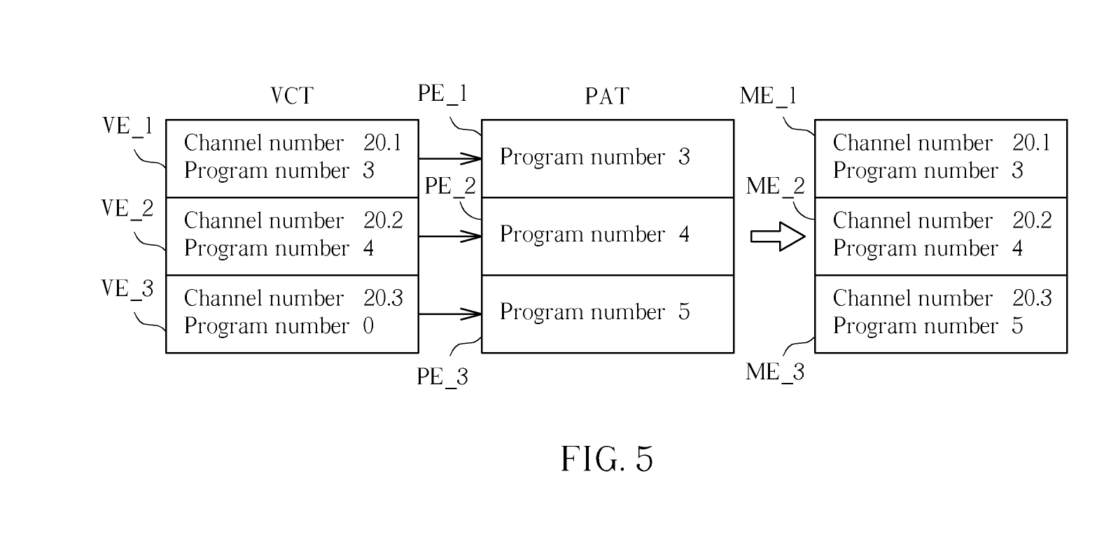

FIG. 5 shows a third example of determining a mapping between a virtual channel number and a program number. As shown, the exemplary loaded information of VCT has three VCT entries VE_1, VE_2, and VE_3. The VCT entry VE_1 records a channel number 20.1 and a program number 3 mapped to the channel number 20.1. The VCT entry VE_2 records a channel number 20.2 and a program number 4 mapped to the channel number 20.2. The VCT entry VE_3 records a channel number 20.3 and a program number 0 mapped to the channel number 20.3. Regarding the exemplary loaded information of PAT, it has three PAT entries PE_1, PE_2, and PE_3 which record program numbers 3, 4, and 5, respectively. As one can see, there is program number inconsistency between the VCT and PAT; however, the total number of the VCT entries is equal to the total number of the PAT entries. As the comparison result of the information of VCT and PAT indicates that the PAT includes PAT entries PE_1 and PE_2 recording program numbers 3 and 4, and the VCT includes VCT entries VE_1 and VE_2 recording program numbers 3 and 4 as well, it is therefore determined that the virtual channel numbers 20.1 and 20.2 recorded in VCT entries VE_1 and VE_2 are mapped to the program numbers 3 and 4, respectively. In addition, as the comparison result of the information of VCT and PAT also indicates that the PAT includes a PAT entry PE_3 recording the program number 5 which is not recorded in any VCT entry, the channel number 20.3 recorded in the VCT entry VE_3 which contains the program number 0 inconsistent with the program number 5 recorded in the PAT entry PE_3 is therefore determined to be mapped to the program number 5 recorded in the PAT entry PE_3. In this way, three mapping records ME_1, ME_2, and ME_3 as shown in FIG. 5 are derived.

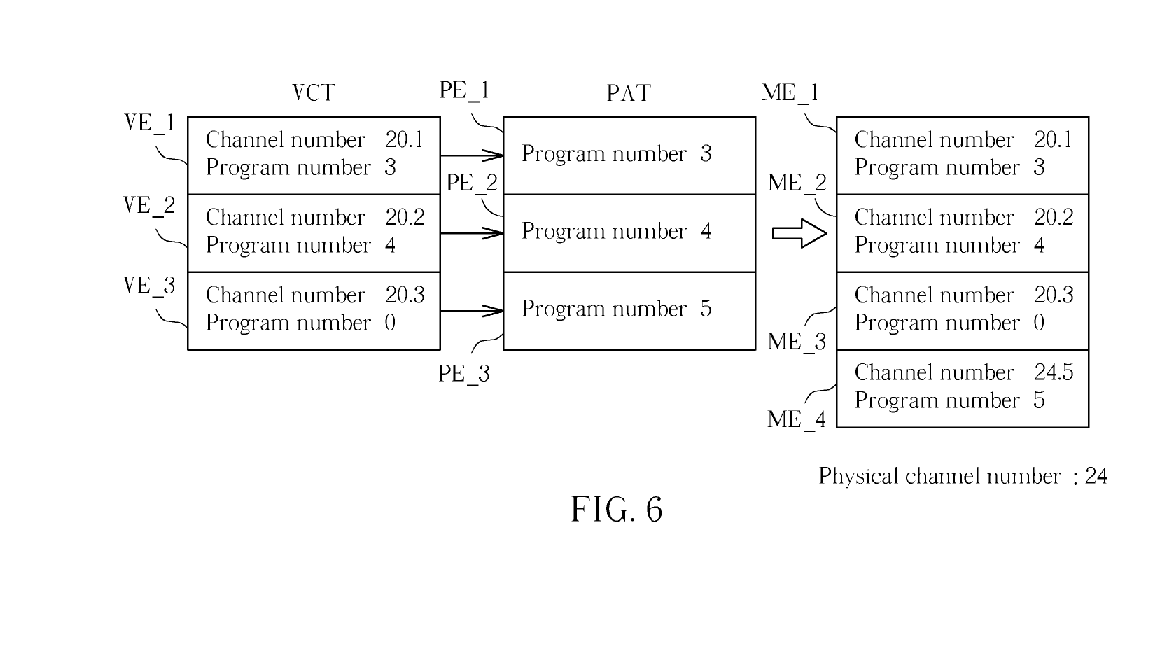

FIG. 6 shows a fourth example of determining a mapping between a virtual channel number and a program number. As shown, the exemplary loaded information of VCT and PAT are similar to those shown in FIG. 5, thus two mapping records ME_1 and ME_2 corresponding to the mapping records ME_1 and ME_2 in FIG. 5 are determined similarly. The detailed description for determining the mapping records ME_1 and ME_2 is thus omitted for brevity. In addition, the comparison result of the information of VCT and PAT also indicates that the PAT includes a PAT entry PE_3 recording the program number 5 which is not recorded in any VCT entry, and the VCT includes a VCT entry recording the program number 0 which is not recorded in any PAT entry. Provided that the currently selected physical channel has a designated physical channel number equal to 24, the channel number 20.3 recorded in the VCT entry VE_3 is determined to be mapped to the program number 0 recorded in the same VCT entry VE_3, while a new channel number which is configured using a major channel number set by the physical channel number 24 and a minor channel number set by the program number 5 is created and then mapped to the program number 5 recorded in the PAT entry PE_3. In this way, four mapping records ME_1, ME_2, ME_3, and ME_4 as shown in FIG. 6 are derived.

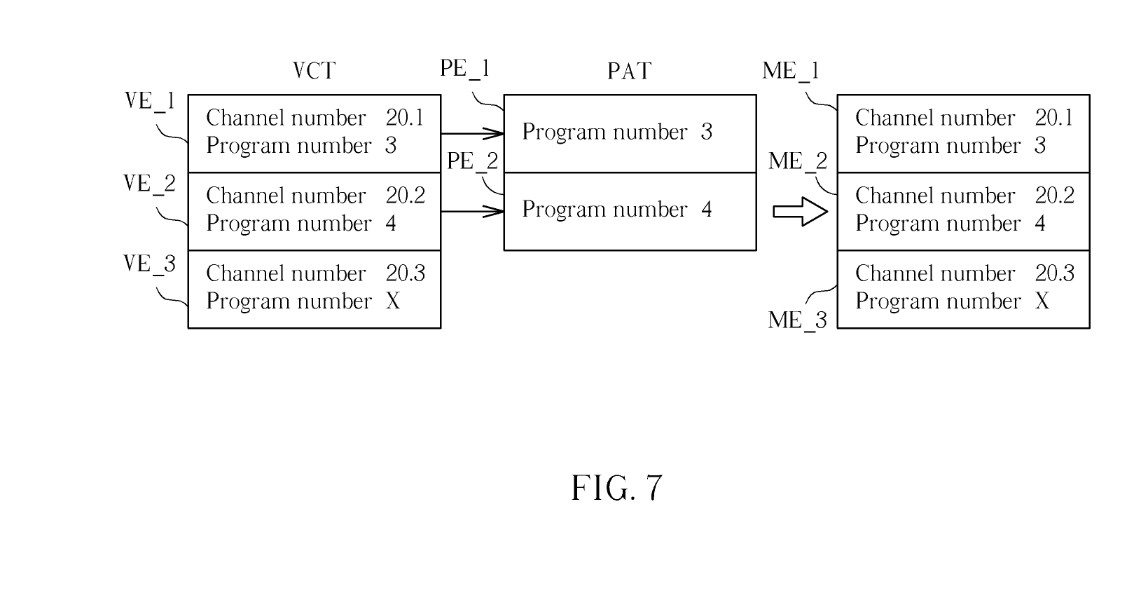

FIG. 7 shows a fifth example of determining a mapping between a virtual channel number and a program number. As shown, the exemplary loaded information of VCT has three VCT entries VE_1, VE_2, and VE_3. The VCT entry VE_1 records a channel number 20.1 and a program number 3 mapped to the channel number 20.1. The VCT entry VE_2 records a channel number 20.2 and a program number 4 mapped to the channel number 20.2. The VCT entry VE_3 records a channel number 20.3 and a program number X mapped to the channel number 20.3. Regarding the exemplary loaded PAT, it has two PAT entries PE_1 and PE_2 which record program numbers 3 and 4, respectively. As one can see, there is program number inconsistency between the VCT and PAT; in addition, the total number of the VCT entries is unequal to the total number of the PAT entries. Specifically, the total number of the VCT entries is more than that of the PAT entries. As the comparison result of the information of VCT and PAT indicates that the PAT includes PAT entries PE_1 and PE_2 recording program numbers 3 and 4, and the VCT includes VCT entries VE_1 and VE_2 recording program numbers 3 and 4 as well, it is therefore determined that the virtual channel numbers 20.1 and 20.2 recorded in VCT entries VE_1 and VE_2 are mapped to the program numbers 3 and 4, respectively. In addition, the comparison result of the information of VCT and PAT also indicates that the VCT includes a VCT entry VE_3 recording the program number X which is not recorded in any PAT entry. The channel number 20.3 recorded in the VCT entry VE_3 is therefore determined to be mapped to the program number X recorded in the same VCT entry VE_3. In this way, three mapping records ME_1, ME_2, and ME_3 as shown in FIG. 7 are derived.

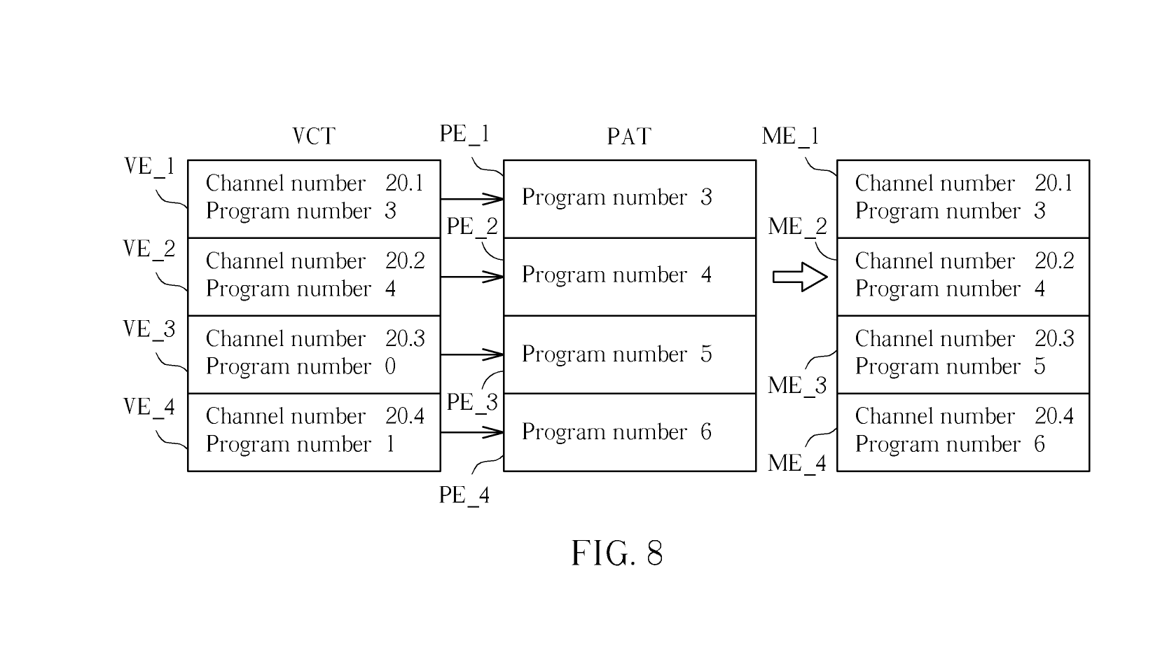

FIG. 8 shows a sixth example of determining a mapping between a virtual channel number and a program number. As shown, the exemplary loaded information of VCT has four VCT entries VE_1, VE_2, VE_3, and VE_4. The VCT entry VE_1 records a channel number 20.1 and a program number 3 mapped to the channel number 20.1. The VCT entry VE_2 records a channel number 20.2 and a program number 4 mapped to the channel number 20.2. The VCT entry VE_3 records a channel number 20.3 and a program number 0 mapped to the channel number 20.3. The VCT entry VE_4 records a channel number 20.4 and a program number 1 mapped to the channel number 20.4. Regarding the exemplary loaded PAT, it has four PAT entries PE_1, PE_2, PE_3, and PE_4 which record program numbers 3, 4, 5, and 6, respectively. As one can see, there is program number inconsistency between the VCT and PAT; however, the total number of the VCT entries is equal to that of the PAT entries. As the comparison result of the information of VCT and PAT indicates that the PAT includes PAT entries PE_1 and PE_2 recording program numbers 3 and 4, and the VCT includes VCT entries VE_1 and VE_2 recording program numbers 3 and 4 as well, it is therefore determined that the virtual channel numbers 20.1 and 20.2 recorded in VCT entries VE_1 and VE_2 are mapped to the program numbers 3 and 4, respectively. In addition, the comparison result of the information of VCT and PAT also indicates that the PAT includes PAT entries PE_3 and PE_4 recording the program number 5 and 6 respectively which are not recorded in any VCT entry. Therefore, the channel number 20.3 recorded in the VCT entry VE_3 is determined to be mapped to the program number 5 recorded in the PAT entry PE_3, and the channel number 20.4 recorded in the VCT entry VE_4 is determined to be mapped to the program number 6 recorded in the PAT entry PE_4. In this way, four mapping records ME_1, ME_2, ME_3, and ME_4 as shown in FIG. 8 are derived.

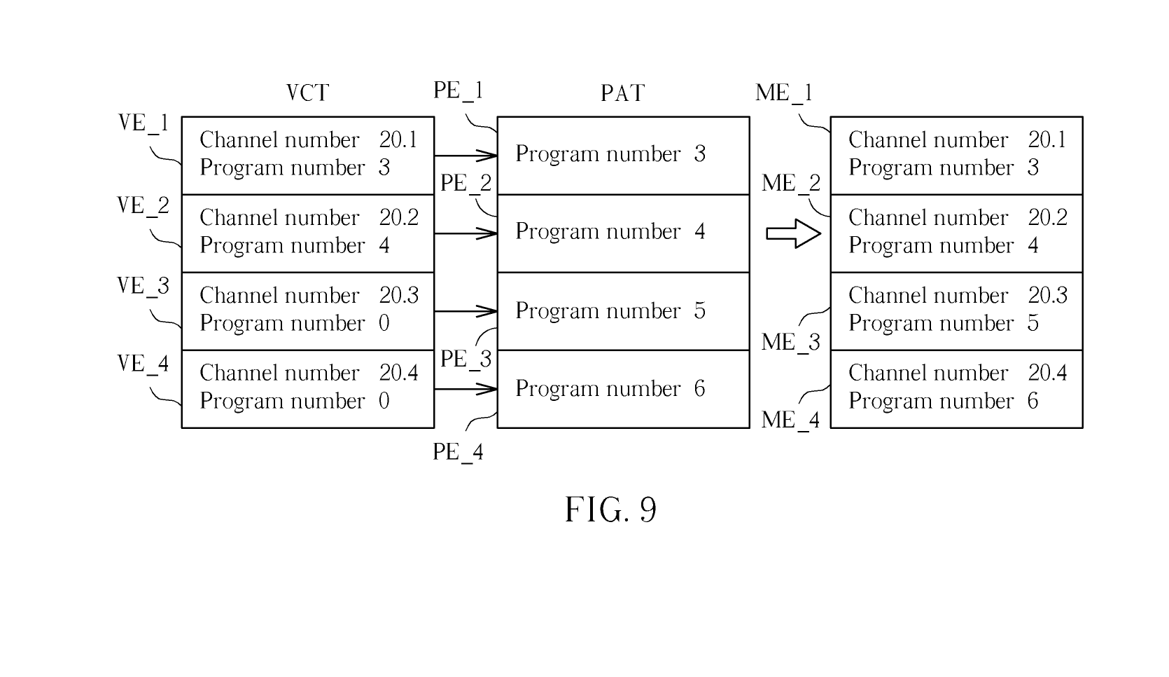

FIG. 9 shows a seventh example of determining a mapping between a channel number and a program number. As shown, the exemplary loaded information of VCT has four VCT entries VE_1, VE_2, VE_3, and VE_4. The VCT entry VE_1 records a channel number 20.1 and a program number 3 mapped to the channel number 20.1. The VCT entry VE_2 records a channel number 20.2 and a program number 4 mapped to the channel number 20.2. The VCT entry VE_3 records a channel number 20.3 and a program number 0 mapped to the channel number 20.3. The VCT entry VE_4 records a channel number 20.4 and the program number 0 mapped to the channel number 20.4. Please note that the same program number 0 is erroneously recorded in different VCT entries in this exemplary embodiment. Regarding the exemplary loaded PAT, it has four PAT entries PE_1, PE_2, PE_3, and PE_4 that record program numbers 3, 4, 5, and 6, respectively. As one can see, there is program number inconsistency between the VCT and PAT; however, the total number of the VCT entries is equal to that of the PAT entries. As the comparison result of the information of VCT and PAT indicates that the PAT includes PAT entries PE_1 and PE_2 recording program numbers 3 and 4, and the VCT includes VCT entries VE_1 and VE_2 recording program numbers 3 and 4 as well, it is therefore determined that the virtual channel numbers 20.1 and 20.2 recorded in VCT entries VE_1 and VE_2 are mapped to the program numbers 3 and 4, respectively. In addition, the comparison result of the information of VCT and PAT also indicates that the PAT includes PAT entries PE_3 and PE_4 recording the program number 5 and 6 respectively which are not recorded in any VCT entry. Therefore, the channel number 20.3 recorded in the VCT entry VE_3 is determined to be mapped to the program number 5 recorded in the PAT entry PE_3, and the channel number 20.4 recorded in the VCT entry VE_4 is determined to be mapped to the program number 6 recorded in the PAT entry PE_4. In this way, four mapping records ME_1, ME_2, ME_3, and ME_4 as shown in FIG. 9 are derived.

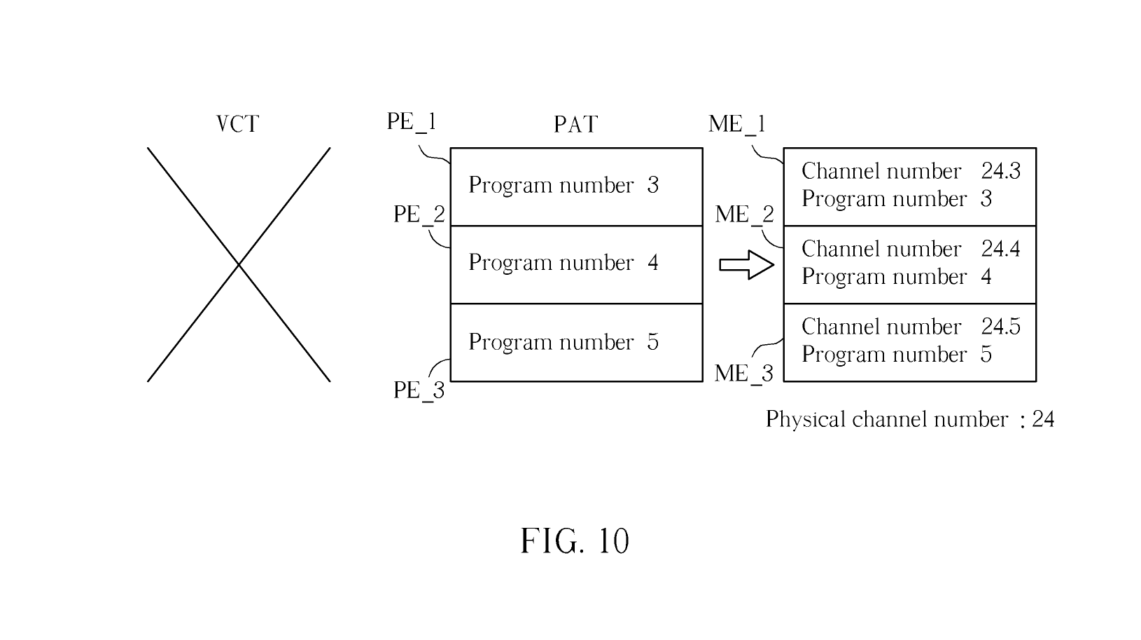

In a second case where only the information of PAT is available from the selected communication channel, each mapping between a channel number and a program number is derived using the loaded information of PAT (Steps 120, 122, 124). FIG. 10 shows an eighth example of determining a mapping between a virtual channel number and a program number. As shown, the exemplary loaded information of PAT includes three PAT entries PE_1, PE_2, and PE_3 which record program numbers 3, 4, and 5, respectively. In this exemplary embodiment, a plurality of new channel numbers are created and then mapped to the program numbers 3, 4, and 5, respectively. Provided that the currently selected physical channel has a designated physical channel number equal to 24, the new channel number mapped to the program number 3 recorded in the PAT entry PE_1 is configured using a major channel number set by the physical channel number 24 and a minor channel number set by the program number 3; similarly, the new channel number mapped to the program number 4 recorded in the PAT entry PE_2 is configured using a major channel number set by the physical channel number 24 and a minor channel number set by the program number 4, and the new channel number mapped to the program number 5 recorded in the PAT entry PE_3 is configured using a major channel number set by the physical channel number 24 and a minor channel number set by the program number 5. In this way, three mapping records ME_1, ME_2, and ME_3 as shown in FIG. 10 are derived, even though the VCT is unavailable.

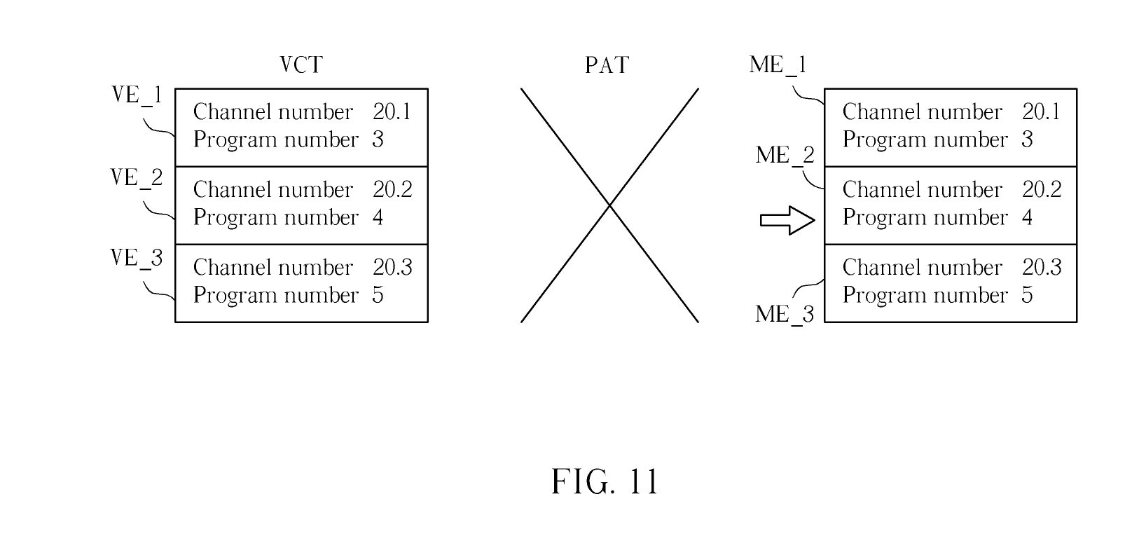

In a third case where only the information of VCT is available from the selected communication channel, each mapping between a channel number and a program number is derived using the loaded VCT (Steps 126, 128, 130). FIG. 11 shows a ninth example of determining a mapping between a virtual channel number and a program number. As shown, the mapping records ME_1, ME_2, and ME_3 are directly derived using the VCT entries VE_1, VE_2, and VE_3, respectively.

After all of the communication channels (i.e., physical channels) have been scanned, a channel list (not shown) can be generated through collecting the aforementioned mapping records derived using the information of VCT and/or PAT for each scanned physical channel (Step 132).

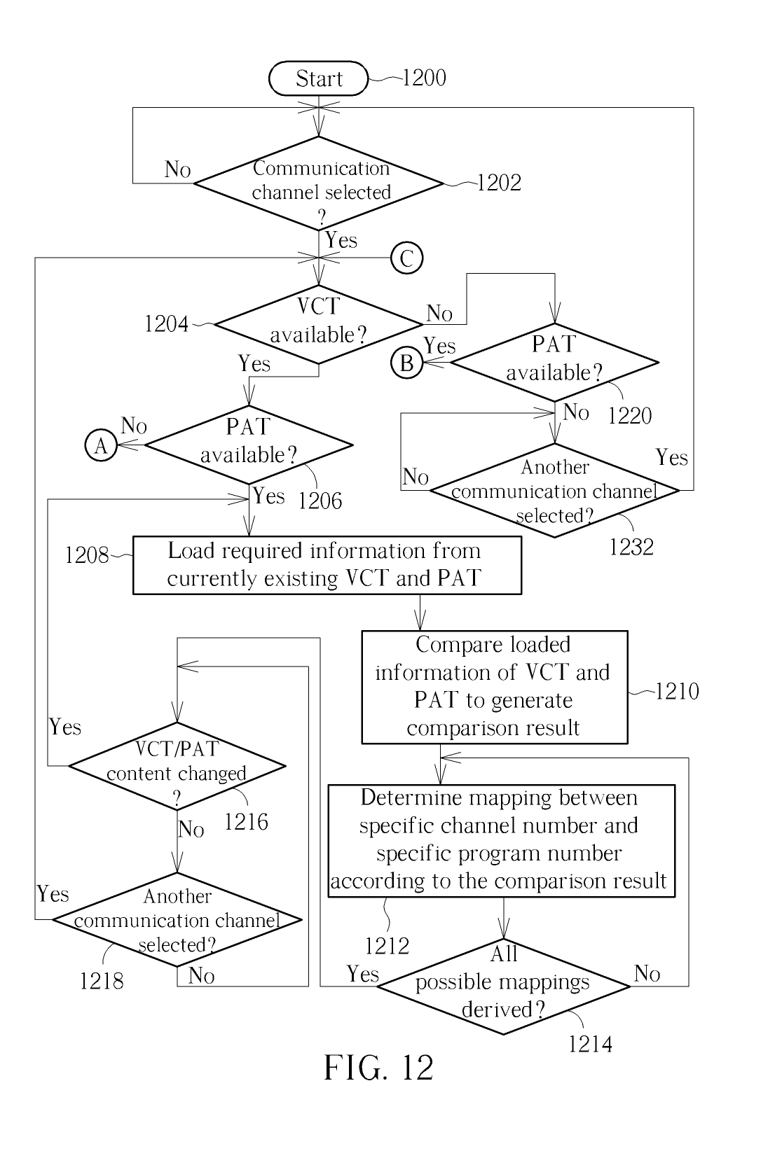

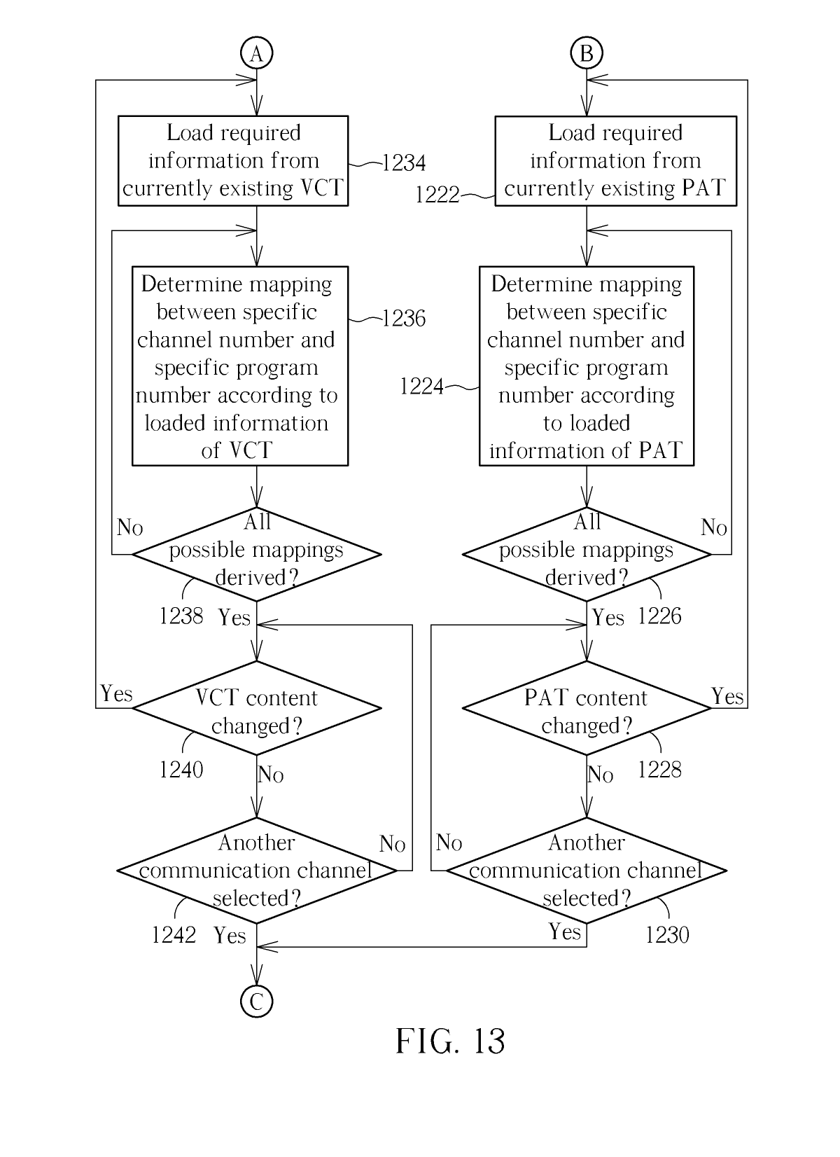

The aforementioned method employed in a channel list creation process is for illustrative purposes only, and is not meant to be a limitation of the present invention. For example, the method of setting at least a mapping between a virtual channel number and a program number is executed each time a physical channel change is made by the user or content changes are found in the received information of VCT or PAT. Please refer to FIG. 12 in conjunction with FIG. 13. FIG. 12 is a flowchart illustrating a method of setting at least a mapping between a virtual channel number and a program number according to a second exemplary embodiment of the present invention. FIG. 13 is a continued flow of FIG. 12. Please note that if the result is substantially the same, the steps are not required to be executed in the exact order shown in FIG. 12 and FIG. 13. The exemplary flow shown in FIG. 12 and FIG. 13 includes steps as follows.

Step 1200: Start.

Step 1202: Is a communication channel with a designated physical channel number selected? If yes, go to step 1204; otherwise, repeat step 1202 to keep monitoring.

Step 1204: Check if a virtual channel table (VCT) exists in the selected communication channel. If yes, go to step 1206; otherwise, go to step 1220.

Step 1206: Check if a program association table (PAT) exists in the selected communication channel. If yes, go to step 1208; otherwise, go to step 1234.

Step 1208: Load required information from currently existing VCT and PAT.

Step 1210: Compare the loaded information of VCT and PAT to generate a comparison result.

Step 1212: Determine a mapping between a specific channel number and a specific program number according to the comparison result, wherein at least one of the specific channel number and the specific program number is recorded in the information of VCT and the PAT.

Step 1214: Are all of the possible mappings derived using the loaded information of VCT and PAT? If yes, go to step 1216; otherwise, go to step 1212 to determine another mapping.

Step 1216: Check if at least one of the information of VCT and PAT has content changes. If yes, go to step 1208 to update the mappings; otherwise, go to step 1218.

Step 1218: Is a communication channel with another designated physical channel number selected? If yes, go to step 1204; otherwise, go to step 1216.

Step 1220: Check if a program association table (PAT) exists in the selected communication channel. If yes, go to step 1222; otherwise, go to step 1232.

Step 1222: Load required information from currently existing PAT.

Step 1224: Determine a mapping between a specific channel number and a specific program number according to the loaded information of PAT, wherein the specific program number is recorded in the loaded information of PAT.

Step 1226: Are all of the possible mappings derived using the loaded information of PAT? If yes, go to step 1228; otherwise, go to step 1224 to determine another mapping.

Step 1228: Check if information of the next PAT received via the selected communication channel has content changes. If yes, go to step 1222 to update the mappings; otherwise, go to step 1230.

Step 1230: Is a communication channel with another designated physical channel number selected? If yes, go to step 1204; otherwise, go to step 1228.

Step 1232: Is a communication channel with another designated physical channel number selected? If yes, go to step 1204; otherwise, repeat step 1232 to keep monitoring.

Step 1234: Load required information from currently existing VCT.

Step 1236: Determine a mapping between a specific channel number and a specific program number according to the loaded information of VCT, wherein the specific channel number and the specific program number are recorded in the loaded information of VCT.

Step 1238: Are all of the possible mappings derived using the loaded information of VCT? If yes, go to step 1240; otherwise, go to step 1236 to determine another mapping.

Step 1240: Check if information of the next VCT received via the selected communication channel has content changes. If yes, go to step 1234 to update the mappings; otherwise, go to step 1242.

Step 1242: Is a communication channel with another designated physical channel number selected? If yes, go to step 1204; otherwise, go to step 1240.

When a communication channel (i.e., a physical channel) with a designated physical channel number is selected due to a physical channel change (Steps 1202, 1230, 1232, and 1242), the operation of setting at least a mapping between a virtual channel number and a program number is executed (Steps 1204-1214, 1222-1226, 1234-1238). In addition, when a VCT/PAT content change is detected, for example, by a receiver end (Steps 1216, 1228, 1240), the operation of setting at least a mapping between a channel number and a program number is executed to update the mappings for the currently selected physical channel. As mentioned above, it is possible that the VCT and PAT are both available from the selected communication channel, only the PAT is available from the selected communication channel, or only the VCT is available from the selected communication channel. As a person skilled in the art would readily understand how to determine a mapping between a channel number and a program number under one of these cases after reading above paragraphs directed to examples shown in FIG. 3-FIG. 11, further description is omitted here for the sake of brevity.

It should be noted that the timing of initiating the execution of identifying a mapping between a virtual channel number and a program number is for illustrative purposes only. Any alternative design without departing the spirit of the present is feasible. In addition, any implementation which uses the mapping schemes proposed in the present invention falls in the scope of the present invention. Furthermore, steps 1208, 1222, and 1234 shown in FIG. 12 and FIG. 13 employ the aforementioned partial data loading scheme to load the required information only, which reduces the memory requirement greatly.

In conclusion, even though the source end of the digital television broadcasting fails to provide a complete and error-free VCT, the exemplary method of the present invention is capable of identifying any possible mapping between a channel number (e.g., a virtual channel number) and a program number according to a first table complying with a specific television standard (e.g., a VCT complying with the ATSC standard) and a second table complying with a specific MPEG standard (e.g., a PAT complying with the MPEG-2 standard). More specifically, in certain exemplary embodiments of the present invention, the program numbers recorded in PAT are referenced for setting the mappings. As a result, the number of channels that the user can select can be increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of setting at least a mapping between a channel number and a program number, comprising:
retrieving information from a virtual channel table (VCT) and a program association table (PAT) transmitted via a communication channel;
comparing the retrieved information of the VCT and the PAT to generate a comparison result; and
determining a mapping between a specific channel number and a specific program number according to the comparison result, wherein the program number of the PAT is referenced first before the retrieved information of the VCT is referenced when determining of the mapping.

2. The method of claim 1, wherein the step of determining the mapping between the specific channel number and the specific program number according to the comparison result comprises:
when the comparison result indicates that the retrieved information of the PAT includes a PAT entry recording the specific program number, and the retrieved information of the VCT includes a VCT entry recording the specific channel number and the specific program number, determining that the specific channel number is mapped to the specific program number.

3. The method of claim 1, wherein the step of determining the mapping between the specific channel number and the specific program number according to the comparison result comprises:
when the comparison result indicates that the retrieved information of the PAT includes a PAT entry recording the specific program number, and the retrieved information of the VCT does not include a VCT entry recording the specific program number, determining the specific channel number and then mapping the specific channel number to the specific program number.

4. The method of claim 3, wherein the step of determining the specific channel number comprises:
creating a new channel number that is not recorded in the retrieved information of the VCT to act as the specific channel number.

5. The method of claim 4, wherein each VCT entry of the retrieved information of the VCT records a program number that is recorded in a PAT entry of the retrieved information of the PAT table.

6. The method of claim 4, wherein the VCT and the PAT are transmitted via the communication channel with a designated physical channel number, and the step of creating the new channel number comprises:
utilizing the designated physical channel number and the specific program number to set the new channel number.

7. The method of claim 3, wherein the retrieved information of the VCT includes a VCT entry recording a particular channel number and a program number which is not recorded in a PAT entry of the retrieved information of the PAT, and the step of determining the specific channel number comprises:
utilizing the particular channel number to act as the specific channel number.

8. The method of claim 1, wherein the step of determining the mapping between the specific channel number and the specific program number according to the comparison result comprises:
when the comparison result indicates that the retrieved information of the VCT includes a VCT entry recording the specific channel number and the specific program number which is not recorded in a PAT entry of the retrieved information of the PAT, determining that the specific channel number is mapped to the specific program number.

9. The method of claim 1, wherein the step of comparing the retrieved information of the VCT and the PAT and the step of determining the mapping between the specific channel number and the specific program number are performed during a channel list creation process.

10. The method of claim 1, wherein the step of comparing the retrieved information of the VCT and the PAT and the step of determining the mapping between the specific channel number and the specific program number are performed when the retrieved information of at least one of the VCT and the PAT has content changes.

11. The method of claim 1, wherein the step of comparing the retrieved information of the VCT and the PAT and the step of determining the mapping between the specific channel number and the specific program number are performed when a communication channel change occurs.

12. A method of setting at least a mapping between a channel number and a program number, comprising:
retrieving information from a first table and a second table transmitted via a communication channel, wherein the first table complies with a specific television standard, and the second table complies with a specific moving picture experts group (MPEG) standard;
comparing the retrieved information of the first table and the second table to generate a comparison result; and
determining a mapping between a specific channel number and a specific program number according to the comparison result, wherein the program number of the PAT is referenced first before the retrieved information of the VCT is referenced when determining of the mapping.

13. The method of claim 12, wherein the step of determining the mapping between the specific channel number and the specific program number according to the comparison result comprises:
when the comparison result indicates that the retrieved information of the second table includes an entry recording the specific program number, and the retrieved information of the first table includes an entry recording the specific channel number and the specific program number, determining that the specific channel number is mapped to the specific program number.

14. The method of claim 12, wherein the step of determining the mapping between the specific channel number and the specific program number according to the comparison result comprises:
when the comparison result indicates that the retrieved information of the second table includes an entry recording the specific program number, and the retrieved information of the first table does not include an entry recording the specific program number, determining the specific channel number and then mapping the specific channel number to the specific program number.

15. The method of claim 14, wherein the step of determining the specific channel number comprises:
creating a new channel number that is not recorded in the retrieved information of the first table to act as the specific channel number.

16. The method of claim 15, wherein each entry of the retrieved information of the first table records a program number that is recorded in an entry of the retrieved information of the second table.

17. The method of claim 15, wherein the first table and the second table are transmitted via the communication channel with a designated physical channel number, and the step of creating the new channel number comprises:
utilizing the designated physical channel number and the specific program number to set the new channel number.

18. The method of claim 14, wherein the retrieved information of the first table includes an entry recording a particular channel number and a program number which is not recorded in an entry of the retrieved information of the second table, and the step of determining the specific channel number comprises:
utilizing the particular channel number to act as the specific channel number.

19. The method of claim 12, wherein the step of determining the mapping between the specific channel number and the specific program number according to the comparison result comprises:
when the comparison result indicates that the retrieved information of the first table includes an entry recording the specific channel number and the specific program number which is not recorded in an entry of the retrieved information of the second table, determining that the specific channel number is mapped to the specific program number.

20. The method of claim 12, wherein the specific television standard is an advanced television systems committee (ATSC) standard, and the specific MPEG standard is a moving picture experts group-2 (MPEG-2) standard.
